(19) United States
(12) Patent Application Publication
(10) Pub. No.: US 2023/0344233 A1
(43) Pub. Date: Oct. 26, 2023

(54) GENERATING CONTROL SIGNALS FOR ENERGY SOURCES

(71) Applicant: Battelle Energy Alliance, LLC, Idaho Falls, ID (US)

(72) Inventors: Vivek Kumar Singh, Ammon, ID (US); S M Shafiul Alam, Idaho Falls, ID (US); Thomas M. Mosier, Idaho Falls, ID (US)

(21) Appl. No.: 18/304,686

(22) Filed: Apr. 21, 2023

Related U.S. Application Data
(60) Provisional application No. 63/333,998, filed on Apr. 22, 2022.

(51) Int. Cl. H02J 3/32; H02J 7/00; H02J 7/34

(52) U.S. Cl. CPC H02J 3/32; H02J 7/00712; H02J 7/345; H02J 2207/50

(57) ABSTRACT

Embodiments of the present disclosure relate to generating control signals for energy sources. Some embodiments include a method, the method including generating a first control signal at least partially responsive to a request signal and at least partially responsive to a first capability of a first energy source to change a first energy output. The first control signal may be indicative of a first portion of a requested amount of energy to be provided by the first energy source. The method may also include generating a second control signal at least partially responsive to the request signal and at least partially responsive to a second capability of a second energy source to change a second energy output. The second control signal may be indicative of a second portion of the requested amount of energy to be provided by the second energy source. Related devices, systems and methods are also disclosed.

### PRIORITY CLAIM

This application claims the benefit of the filing date of U.S. Provisional Patent Application Ser. No. 63/333,998, filed Apr. 22, 2022, for “GENERATING CONTROL SIGNALS FOR ENERGY SOURCES,” the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### FIELD

Embodiments of the present disclosure relate to generating control signals for energy sources. More specifically, some embodiments of the present disclosure relate to generating a control signal for quickly-responding energy sources and a control signal for slowly-responding energy sources.

### BACKGROUND

Some energy sources are capable of changing amounts of energy output thereby more quickly than other energy sources are capable of changing respective amounts of energy output thereby. For example, some energy sources may be capable of changing an amount of energy output within a time duration without putting stress on the energy source; while other energy sources may not be capable of changing a respective amount of energy output within the time duration without stress.

### BRIEF DESCRIPTION THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a functional block diagram illustrating an example system according to one or more embodiments.

FIG. 2 is a functional block diagram illustrating an example system according to one or more embodiments.

FIGS. 3A and 3B collectively illustrate a flowchart of an example method, according to one or more embodiments.

FIG. 4 illustrates a block diagram of an example device that may be used to implement various functions, operations, acts, processes, and/or methods, in accordance with one or more embodiments.

### DETAILED DESCRIPTION

In the following detailed description, reference is made to the accompanying drawings, which form a part hereof, and in which are shown, by way of illustration, specific embodiments of the disclosure that may be practiced. These embodiments are described in sufficient detail to enable those of ordinary skill in the art to practice the invention, and it is to be understood that other embodiments may be utilized, and that structural, logical, and electrical changes may be made within the scope of the disclosure.

In this description, specific implementations are shown and described only as examples and should not be construed as the only way to implement the present disclosure unless specified otherwise herein. It will be readily apparent to one of ordinary skill in the art that the various embodiments of the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Referring in general to the following description and accompanying drawings, various embodiments of the present disclosure are illustrated to show their structure and method of operation. Common elements of the illustrated embodiments may be designated with similar reference numerals. It should be understood that the figures presented are not meant to be illustrative of actual views of any particular portion of the actual structure or method, but are merely idealized representations employed to more clearly and fully depict the present invention defined by the claims below.

It should be appreciated and understood that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the embodiments of the present disclosure may be implemented on any number of data signals including a single data signal.

It should be further appreciated and understood that the various illustrative logical blocks, modules, circuits, and algorithm acts described in connection with embodiments disclosed herein may be implemented as electronic hardware, computer software, or combinations of both. To clearly illustrate this interchangeability of hardware and software, various illustrative components, blocks, modules, circuits, and acts are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments of the disclosure described herein.

The various illustrative logical blocks, modules, and circuits described in connection with the embodiments disclosed herein may be implemented or performed with a general-purpose processor, a special-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the general-processor may be any conventional processor, controller, microcontroller, or state machine. A general-purpose processor may be considered a special-purpose processor while the general-purpose processor executes instructions (e.g., software code) stored on a computer-readable medium. A processor may also be implemented as a combination of computing devices, such as a combination of a DSP and a microprocessor, a plurality of microprocessors, one or more microprocessors in conjunction with a DSP core, or any other such configuration.

When executed as firmware or software, the instructions for performing the processes described herein may be stored on a computer-readable medium. A computer-readable medium includes, but is not limited to, non-transitory storage media, such as magnetic and optical storage devices such as disk drives, magnetic tape, CDs (compact disks), DVDs (digital versatile discs or digital video discs), and semiconductor devices such as RAM, DRAM, ROM, EPROM, and Flash memory.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

Some energy sources are capable of changing amounts of energy output thereby more quickly than other energy sources are capable of changing respective amounts of energy output thereby. For example, some energy sources may be capable of changing an amount of energy output within a time duration without putting stress on the energy source; while other energy sources may not be capable of changing a respective amount of energy output within the time duration without stress.

In the present disclosure, the terms “quick,” “quickly,” “quickly-responding,” “slow,” “slowly,” “slowly-responding” and like terms may be relative. For example, referring to an energy source as “quick” may indicate that the energy source is more capable of changing its amount of energy output than another energy source (which may be referred to as “slow”).

Some energy sources may provide energy responsive to a control signal. For example, some energy sources may change an amount of energy provided thereby responsive to changes in a control signal. Thus, energy sources may be referred to as “quickly-responding,” if they are more capable of responding quickly to a control signal than other energy sources (e.g., “slowly-responding” energy sources). Some control signals may call for quick responses, such control signals may be referred to as “quick” control signals. Other control signals may not call for quick responses, such control signals may be referred to as “slow” control signals.

Some energy sources that are quick may be capable of changing an amount of energy output by a certain amount in under 10 seconds; for example, some quick energy sources may be capable of changing an amount of energy output by 1 megawatt in under four seconds or under one second. Batteries, ultracapacitors, and diesel generators may be examples of quick energy sources.

Other energy sources may be less capable of responding quickly to control signals. For example, other energy sources may be incapable of changing an amount of energy provided by the certain amount in under 10 seconds. Alternatively, the other energy sources may be capable of changing the amount of energy provided by the certain amount, but only by undergoing stress. Such stress may affect a long-term performance of the other energy sources or be otherwise costly or have other disadvantages. Energy generators including turbines (e.g., generators of a hydropower plant) may be examples of slow energy sources.

Examples of suitable energy sources (including some energy sources that are quicker than others) include: solar power plants, wind power plants, hydroelectric power plants, geothermal power plants, biomass reactors, nuclear power plants, coal-fired power plants, diesel-fired power plants, gas-fired power plants, tidal power plants, etc.

In other words, quick energy sources may be capable of changing an amount of energy provided thereby by more than slow energy sources are capable of changing a respective amount of energy provided thereby over the same time. In the present disclosure, including in the description above, references to changing an amount of energy output may refer to any amount of change or may refer to a change representing any fraction of energy currently being output. For example, a quick energy source may be capable of changing an amount of energy provided by megawatts in one second. The megawatts may be more than or less than the amount of energy provided by the quick energy source prior to the change. For example, a quick energy source may go from providing 0 megawatts to providing tens of megawatts in one second, or from providing tens of megawatts to providing 0 megawatts in one second. As another example, a slow energy source may be capable of changing an amount of energy provided thereby by kilowatts in one second and yet may be considered a “slow” energy source because the prior example “quick” energy source is capable of a greater change in output over the same duration. The change of kilowatts may be a small percentage (e.g., one percent or less) of an amount of energy being provided by the slow energy source prior to the change.

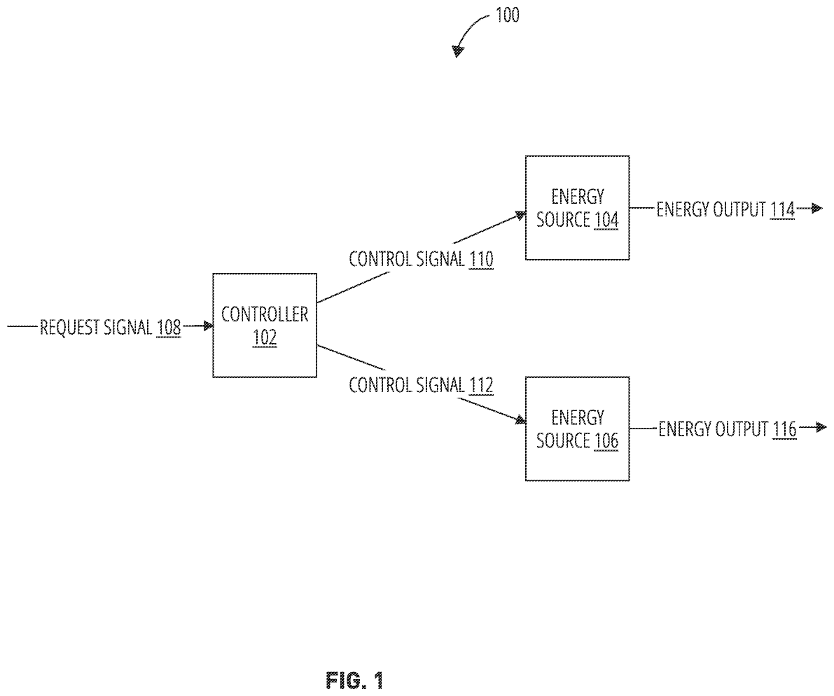

FIG. 1 is a functional-block diagram illustrating an example system 100 according to one or more embodiments.

System 100 includes a controller 102, a first energy source 104, and a second energy source 106. First energy source 104 may be capable of changing first energy output 114 more quickly than second energy source 106 is capable of changing second energy output 116. Controller 102 may be configured to receive a request signal 108 indicative of a requested amount of energy. Controller 102 may also be configured to generate a first control signal 110 at least partially responsive to request signal 108. First control signal 110 may be indicative of a first portion of the requested amount of energy to be provided by first energy source 104. Controller 102 may also be configured to generate a second control signal 112 at least partially responsive to request signal 108. Second control signal 112 may be indicative of a second portion of the requested amount of energy to be provided by second energy source 106. Controller 102 may be configured to provide first control signal 110 to first energy source 104 and/or to provide second control signal 112 to second energy source 106 (e.g., via a first output terminal and a second output terminal, respectively, of the controller 102).

First energy source 104 and second energy source 106 may be, or may include any suitable energy source. First energy source 104 and second energy source 106 may include any number of energy generators and/or any number of energy-storage devices.

As an example, first energy source 104 may include a quickly-responding energy source. For example, first energy source 104 may be, or may include, a battery energy-storage system (BESS) or a hybrid energy-storage system (HESS) including one or more batteries and/or one or more ultracapacitors.

As an example, second energy source 106 may include a slowly-responding energy source. For example, second energy source 106 may include one or more generators (e.g., a hydropower generator). The generators may include turbines.

Request signal 108 may include a signal indicative of a requested amount of energy. Request signal 108 may be provided to controller 102 from a power-regulation authority. Request signal 108 may be a control signal to control operation of an energy source. Request signal 108 may be used by system 100 as an indication of an amount of energy requested to be provided by first energy source 104 and second energy source 106 collectively. Request signal 108 may be, or may include, an area-control error (ACE) signal. Additionally or alternatively, Request signal 108 may be, or may include, a signal according to one or more specific formats or requirements e.g., a “Regulation A” or “Reg A” signal or a “Regulation D” or “Reg D” signal used in the Pennsylvania New Jersey Maryland Interconnection (PJM) and/or as defined by the regional transmission organization (RTO). Request signal 108 may be related to a frequency regulation product of an energy market.

Request signal 108 may change over time, e.g., request signal 108 may have multiple values within a second. Request signal 108 may change more quickly than second energy source 106 is capable of responding (or capable of responding without stress).

Controller 102 may be, or may include, any suitable processor, circuit, and/or logic to receive signals, generate signals, and provide signals. Controller 102 may receive request signal 108 and may decompose request signal 108 into a first control signal 110 (e.g., a quick-response signal) and second control signal 112 (e.g., a slow-response signal).

Controller 102 may provide first control signal 110 to first energy source 104 and/or provide second control signal 112 to second energy source 106. First energy source 104 may provide first energy output 114 responsive to first control signal 110. Second energy source 106 may provide second energy output 116 responsive to second control signal 112. First energy output 114 and second energy output 116 may collectively provide the total requested amount of energy of request signal 108.

Controller 102 may generate second control signal 112 at least partially responsive to a capability of second energy source 106 to generate second energy output 116. Specifically, controller 102 may generate second control signal 112 according to a capability of second energy source 106 to quickly respond to second control signal 112. For example, controller 102 may generate second control signal 112 such that second energy source 106 can respond (by generating second energy output 116) without stress, or with an acceptable degree of stress. In the present disclosure, the term “capability,” in reference to an energy source, may refer to how quickly the energy source is able to change the amount of energy output by a certain amount and/or by how much the energy source is able to change energy output within a certain duration of time. For example, a capability may refer to how quickly an energy source is able to change an amount of energy output by 1 megawatt or the capability may refer to how much change to the amount of energy provided the energy source is able to cause within 1 second.

To generate second control signal 112 such that second energy source 106 is able to respond to second control signal 112, controller 102 may generate first control signal 110 to provide a difference between what second energy source 106 is capable of providing without stress and the total amount of energy requested by request signal 108.

Controller 102 may generate first control signal 110 and second control signal 112 by decomposing request signal 108 into a high-frequency portion (e.g., a quick-response signal) and a low-frequency portion (e.g., a slow-response signal). Controller 102 may use a variational mode decomposition to decompose request signal 108 into first control signal 110 and second control signal 112. The decomposition may include decomposing request signal 108 into intrinsic mode functions. Some of the intrinsic mode functions may be related to the quick-response signal and may be used to generate first control signal 110. Others of the intrinsic mode functions may be related to the slow-response signals and may be used to generate second control signal 112.

Controller 102 may be configured to generate first control signal 110 and second control signal 112 responsive to request signal 108 in real time. For example, controller 102 may be configured to generate samples of first control signal 110 and second control signal 112 as samples of request signal 108 are received, for example, a sliding window of data of control signal 112 may be used to generate first control signal 110 and second control signal in real-time. The size of the sliding window may be at least partially based on the response time allowance (i.e., how quickly the energy sources must respond to the control signal).

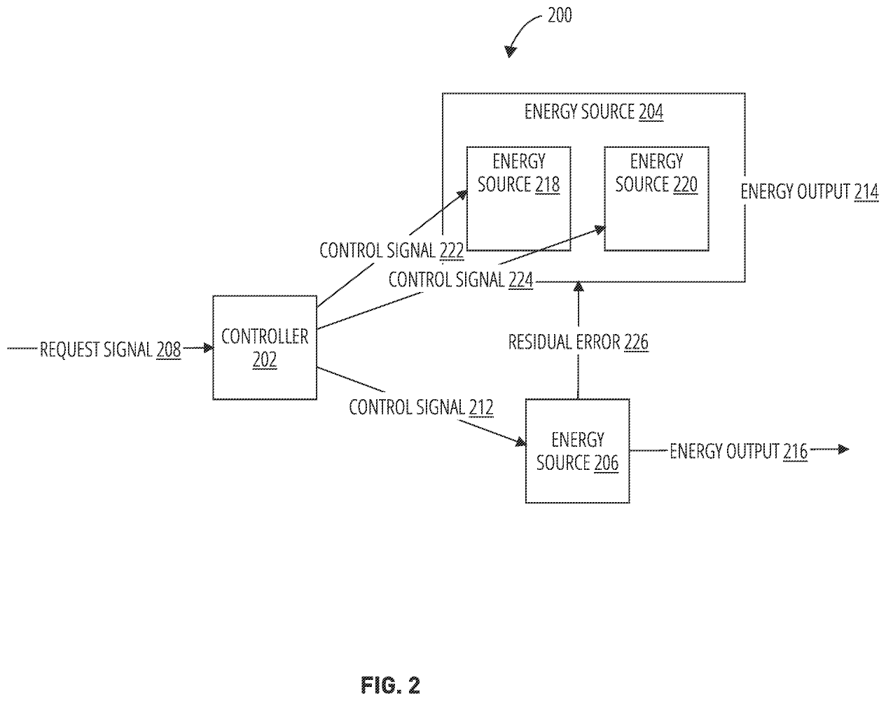

FIG. 2 is a functional-block diagram illustrating an example system 200 according to one or more embodiments.

In the present disclosure, elements of separate drawings that are indicated by reference numbers having the same last two digits may be substantially the same between separate drawings, absent explicit description to the contrary. For example, controller 202 of FIG. 2 may be substantially the same as controller 102 of FIG. 1.

A difference between system 200 and system 100 of FIG. 1 is that in system 200, first energy source 204 includes a third energy source 218 and a fourth energy source 220. First energy source 204 may be a quickly-responding energy source which may be made up of two or more energy sources, which may be of different categories. As an example, third energy source 218 may be any number of energy sources of a first category e.g., batteries and fourth energy source 220 may be any number of energy sources of a second category e.g., ultracapacitors.

In some embodiments, as illustrated in FIG. 2, controller 202 may provide third control signal 222 to third energy source 218 and fourth control signal 224 to fourth energy source 220. Third energy source 218 and fourth energy source 220 may collectively provide first energy output 214 responsive to third control signal 222 and fourth control signal 224.

In some embodiments, controller 202 may provide a first control signal (not illustrated in FIG. 2) to first energy source 204. Controller 202 may further provide weights indicative of an amount of energy to be provided by each of third energy source 218 and fourth energy source 220. The weights may be at least partially responsive to respective capabilities of third energy source 218 and fourth energy source 220. For example, the weights may be based on how quickly the third energy source 218 and the fourth energy source 220 may be able to change respective amounts of energy produced thereby. The third energy source 218 and the fourth energy source 220 may be configured to generate energy responsive to the first control signal and the weights.

In some embodiments, controller 202 may use a variational mode decomposition to decompose request signal 208 into second control signal 212, third control signal 222, and fourth control signal 224. Additionally or alternatively, controller 202 may use a variational mode decomposition to decompose the first control signal into third control signal 222 and fourth control signal 224. In any case, controller 202 may generate third control signal 222 and fourth control signal 224 at least partially responsive to respective capabilities of third energy source 218 and fourth energy source 220. For example, ultracapacitors of fourth energy source 220 may be capable of responding more quickly than batteries of third energy source 218 and generators of second energy source 206. Thus, fourth control signal 224 may call for quicker responses than either of third control signal 222 and second control signal 212 and third control signal 222 may call for a quicker response than second control signal 212.

In some embodiments, controller 202 may determine a residual error 226, which may be a difference between second energy output 216 and an amount of energy requested by second control signal 212. Controller 202 may provide residual error 226 to first energy source 204 such that first energy source 204 may provide the difference. In FIG. 2, residual error 226 is illustrated between second energy source 206 and first energy source 204 for simplicity, even though controller 202 may generate residual error 226 based on a difference between second energy output 216 and second control signal 212.

Controller 202 may determine residual error 226 and may provide residual error 226 to first energy source 204 whether first energy source 204 includes third energy source 218 and fourth energy source 220 or not. In cases where first energy source 204 includes third energy source 218 and fourth energy source 220, controller 202 may determine residual error 226 in two portions, e.g., one portion for third energy source 218 and a second portion for fourth energy source 220. Alternatively, in cases where first energy source 204 includes third energy source 218 and fourth energy source 220, controller 202 may provide weights (based at least in part on respective capabilities of third energy source 218 and fourth energy source 220) with residual error 226 indicative of an amount of energy to be provided by each of third energy source 218 and fourth energy source 220.

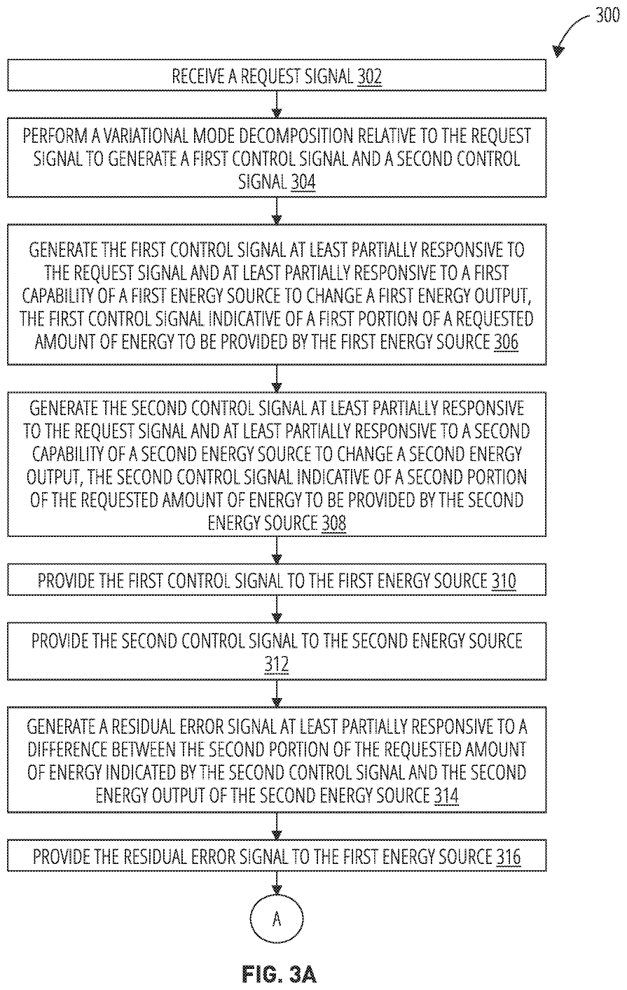

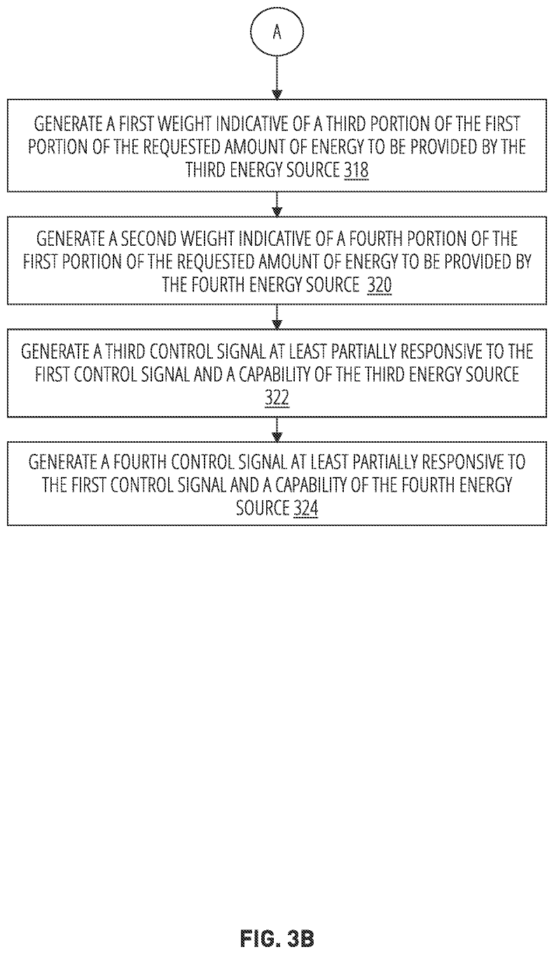

FIGS. 3A and 3B collectively illustrate a flowchart of an example method 300, in accordance with various embodiments of the disclosure. At least a portion of method 300 may be performed, in some embodiments, by a device or system, such as system 100 of FIG. 1, controller 102 of FIG. 1, system 200 of FIG. 2, controller 202 of FIG. 2, or another device or system. Although illustrated as discrete blocks, various blocks may be divided into additional blocks, combined into fewer blocks, or eliminated, depending on the desired implementation.

At operation 302, a request signal may be received. Request signal 108 of FIG. 1 and request signal 208 of FIG. 2 are examples of the request signal received at operation 302.

At operation 304, a variational mode decomposition may be performed relative to the request signal to generate a first control signal and a second control signal. First control signal 110 is an example of the first control signal generated at operation 304. Additionally, either or both of third control signal 222 and fourth control signal 224 may be examples of the first control signal generated at operation 304. Additionally, second control signal 112 and second control signal 212 are examples of the second control signal generated at operation 304.

At operation 306, a first control signal may be generated at least partially responsive to a request signal and at least partially responsive to a first capability of a first energy source to change a first energy output. The first control signal may be indicative of a first portion of a requested amount of energy to be provided by the first energy source. First control signal 110 is an example of the first control signal generated at operation 306. Additionally, either or both of third control signal 222 and fourth control signal 224 may be examples of the first control signal generated at operation 306. A capability of first energy source 104 and a capability of first energy source 204 are examples of the capability responsive to which the first control signal of operation 306 may be generated.

At operation 308, a second control signal may be generated at least partially responsive to the request signal and at least partially responsive to a second capability of a second energy source to change a second energy output. The second control signal may be indicative of a second portion of the requested amount of energy to be provided by the second energy source. Second control signal 112 and second control signal 212 are examples of the second control signal generated at operation 304. A capability of second energy source 106 and a capability of second energy source 206 are examples of the capability responsive to which the second control signal of operation 308 may be generated.

At operation 310, the first control signal may be provided to the first energy source. At operation 312, the second control signal may be provided to the second energy source.

At operation 314, a residual error signal may be generated at least partially responsive to a difference between the second portion of the requested amount of energy indicated by the second control signal and the second energy output of the second energy source. At operation 316, the residual error signal may be provided to the first energy source.

In some embodiments, the first energy source may include a third energy source and a fourth energy source. The third energy source may have different capabilities than the fourth energy source. In such embodiments, method 300 may additionally include an operation 318 at which a first weight indicative of a third portion of the first portion of the requested amount of energy to be provided by the third energy source may be generated. The first weight may be generated based on a capability of the third energy source, e.g., an ability of the third energy source to quickly adjust an amount of energy output thereby.

Also, method 300 may additionally include an operation 320 at which a second weight indicative of a fourth portion of the first portion of the requested amount of energy to be provided by the fourth energy source may be generated. The second weight may be generated based on a capability of the fourth energy source, e.g., an ability of the fourth energy source to quickly adjust an amount of energy output thereby.

The third and the fourth energy sources may provide energy based on the first control signal and the first and second weights. For example, the third energy source may provide energy based on the first control signal and based on the first weight and the fourth energy signal may provide energy based on the first control signal and based on the second weight.

Additionally or alternatively, in embodiments in which the first energy source includes a third energy source and a fourth energy source, method 300 may include an operation 322 at which a third control signal is generated at least partially responsive to the first control signal and a capability of the third energy source.

Also, method 300 may include an operation 324 at which a fourth control signal is generated at least partially responsive to the first control signal and a capability of the fourth energy source.

The third and the fourth energy sources may provide energy based on the third control signal and the fourth control signal, respectively.

Modifications, additions, or omissions may be made to method 300 without departing from the scope of the present disclosure. For example, the operations of method 300 may be implemented in differing order. Furthermore, the outlined operations and actions are only provided as examples, and some of the operations and actions may be optional, combined into fewer operations and actions, or expanded into additional operations and actions without detracting from the essence of the disclosed example.

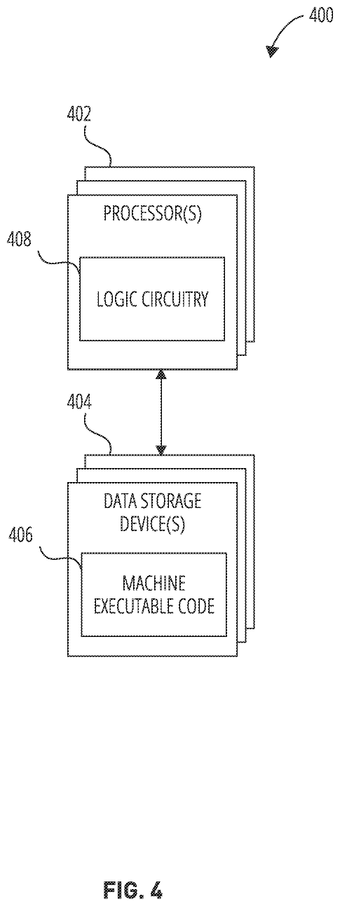

FIG. 4 is a block diagram of an example device 400 that, in various embodiments, may be used to implement various functions, operations, acts, processes, and/or methods disclosed herein. Device 400 includes one or more processors 402 (sometimes referred to herein as “processors 402”) operably coupled to one or more apparatuses such as data storage devices (sometimes referred to herein as “storage 404”), without limitation. Storage 404 includes machine executable code 406 stored thereon (e.g., stored on a computer-readable memory) and processors 402 include logic circuitry 408. Machine executable code 406 include information describing functional elements that may be implemented by (e.g., performed by) logic circuitry 408. Logic circuitry 408 is adapted to implement (e.g., perform) the functional elements described by machine executable code 406. Device 400, when executing the functional elements described by machine executable code 406, should be considered as special purpose hardware configured for carrying out the functional elements disclosed herein. In various embodiments, processors 402 may be configured to perform the functional elements described by machine executable code 406 sequentially, concurrently (e.g., on one or more different hardware platforms), or in one or more parallel process streams.

When implemented by logic circuitry 408 of processors 402, machine executable code 406 is configured to adapt processors 402 to perform operations of embodiments disclosed herein. For example, machine executable code 406 may be configured to adapt processors 402 to perform at least a portion or a totality of method 300 of FIGS. 3A and 3B. As another example, machine executable code 406 may be configured to adapt processors 402 to perform at least a portion or a totality of the operations discussed for system 100 of FIG. 1 and/or system 200 of FIG. 2, and more specifically, one or more of controller 102 of FIG. 1 and/or controller 202 of FIG. 2.

Processors 402 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute computing instructions (e.g., software code) related to embodiments of the present disclosure. It is noted that a general-purpose processor (may also be referred to herein as a host processor or simply a host) may be a microprocessor, but in the alternative, processors 402 may include any conventional processor, controller, microcontroller, or state machine. Processors 402 may also be implemented as a combination of computing devices, such as a combination of a DSP and a microprocessor, a plurality of microprocessors, one or more microprocessors in conjunction with a DSP core, or any other such configuration.

In some embodiments, storage 404 includes volatile data storage (e.g., random-access memory (RAM)), non-volatile data storage (e.g., Flash memory, a hard disc drive, a solid state drive, erasable programmable read-only memory (EPROM), without limitation). In some embodiments, processors 402 and storage 404 may be implemented into a single device (e.g., a semiconductor device product, a system on chip (SOC), without limitation). In some embodiments, processors 402 and storage 404 may be implemented into separate devices.

In some embodiments, machine executable code 406 may include computer-readable instructions (e.g., software code, firmware code). By way of non-limiting example, the computer-readable instructions may be stored by storage 404, accessed directly by processors 402, and executed by processors 402 using at least logic circuitry 408. Also by way of non-limiting example, the computer-readable instructions may be stored on storage 404, transmitted to a memory device (not shown) for execution, and executed by processors 402 using at least logic circuitry 408. Accordingly, in some embodiments logic circuitry 408 includes electrically configurable logic circuitry.

In some embodiments, machine executable code 406 may describe hardware (e.g., circuitry) to be implemented in logic circuitry 408 to perform the functional elements. This hardware may be described at any of a variety of levels of abstraction, from low-level transistor layouts to high-level description languages. At a high-level of abstraction, a hardware description language (HDL) such as an Institute of Electrical and Electronics Engineers (IEEE) Standard hardware description language (HDL) may be used, without limitation. By way of non-limiting examples, Verilog™, SystemVerilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 408 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments, machine executable code 406 may include an HDL, an RTL, a GL description, a mask level description, other hardware description, or any combination thereof.

In some embodiments, where machine executable code 406 includes a hardware description (at any level of abstraction), a system (not shown, but including storage 404) may be configured to implement the hardware description described by machine executable code 406. By way of non-limiting example, processors 402 may include a programmable logic device (e.g., an FPGA or a PLC) and the logic circuitry 408 may be electrically controlled to implement circuitry corresponding to the hardware description into logic circuitry 408. Also by way of non-limiting example, logic circuitry 408 may include hard-wired logic manufactured by a manufacturing system (not shown, but including storage 404) according to the hardware description of machine executable code 406.

Regardless of whether machine executable code 406 includes computer-readable instructions or a hardware description, logic circuitry 408 is adapted to perform the functional elements described by machine executable code 406 when implementing the functional elements of machine executable code 406. It is noted that although a hardware description may not directly describe functional elements, a hardware description indirectly describes functional elements that the hardware elements described by the hardware description are capable of performing.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to some embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated some embodiments, those of ordinary skill in the art will recognize and appreciate that the present invention is not so limited. Rather, many additions, deletions, and modifications to the illustrated and described some embodiments may be made without departing from the scope of the invention as hereinafter claimed along with their legal equivalents. In addition, features from one some embodiment may be combined with features of another some embodiment while still being encompassed within the scope of the invention as contemplated by the inventor.

What is claimed is:

1. A system comprising:
a first energy source configured to provide a first energy output;
a second energy source configured to provide a second energy output, the first energy source capable of changing the first energy output more quickly than the second energy source is capable of changing the second energy output; and
a controller configured to:
receive a request signal indicative of a requested amount of energy;
generate a first control signal at least partially responsive to the request signal, the first control signal indicative of a first portion of the requested amount of energy to be provided by the first energy source;
provide the first control signal to the first energy source;
generate a second control signal at least partially responsive to the request signal, the second control signal indicative of a second portion of the requested amount of energy to be provided by the second energy source; and
provide the second control signal to the second energy source.

2. The system of claim 1, wherein the controller is further configured to generate the first control signal at least partially responsive to a first capability of the first energy source to change the first energy output and
wherein the controller is further configured to generate the second control signal at least partially responsive to a second capability of the second energy source to change the second energy output.

3. The system of claim 1, wherein the first energy source comprises one or more of: one or more batteries and one or more ultracapacitors and wherein the second energy source comprises one or more generators.

4. The system of claim 1, wherein the request signal is a control signal from a servicing authority.

5. The system of claim 1, wherein the controller is further configured to generate the first control signal and the second control signal at least partially based on a variational mode decomposition of the request signal.

6. The system of claim 1, wherein the controller is further configured to:
generate a residual error signal at least partially responsive to a difference between the second portion of the requested amount of energy indicated by the second control signal and the second energy output of the second energy source; and
provide the residual error signal to the first energy source.

7. The system of claim 1, wherein the first energy source comprises a third energy source and a fourth energy source,
wherein the controller is further configured to generate a first weight indicative of a third portion of the first portion of the requested amount of energy to be provided by the third energy source, and
wherein the controller is further configured to generate a second weight indicative of a fourth portion of the first portion of the requested amount of energy to be provided by the fourth energy source.

8. The system of claim 7, wherein the third energy source comprises batteries and wherein the fourth energy source comprises ultracapacitors.

9. The system of claim 1, wherein the first energy source comprises a third energy source and a fourth energy source,
wherein the controller is further configured to generate a third control signal at least partially responsive to the first control signal, and
wherein the controller is further configured to generate a fourth control signal at least partially responsive to the first control signal.

10. The system of claim 9, wherein the controller is further configured to generate the third control signal and the fourth control signal at least partially based on a variational mode decomposition of the first control signal.

11. The system of claim 9, wherein the controller is further configured to generate the third control signal at least partially responsive to a capability of the third energy source; and
wherein the controller is further configured to generate the fourth control signal at least partially responsive to a capability of the fourth energy source.

12. The system of claim 11, wherein the third energy source comprises one or more batteries and wherein the fourth energy source comprises one or more ultracapacitors.

13. A controller comprising:
a first output terminal configured to provide a first control signal to a first energy source;
a second output terminal configured provide a second control signal to a second energy source; and
circuitry configured to:
generate the first control signal to be provided to the first energy source via the first output terminal at least partially responsive to a request signal and at least partially responsive to a first capability of the first energy source to change a first energy output of the first energy source, the first control signal indicative of a first portion of a requested amount of energy to be provided by the first energy source; and
generate the second control signal to be provided to the first energy source via the second output terminal at least partially responsive to the request signal and at least partially responsive to a second capability of the second energy source to change a second energy output of the second energy source, the second control signal indicative of a second portion of the requested amount of energy to be provided by the second energy source.

14. A method comprising:
generating a first control signal at least partially responsive to a request signal and at least partially responsive to a first capability of a first energy source to change a first energy output of the first energy source, the first control signal indicative of a first portion of a requested amount of energy to be provided by the first energy source; and
generating a second control signal at least partially responsive to the request signal and at least partially responsive to a second capability of a second energy source to change a second energy output of the second energy source, the second control signal indicative of a second portion of the requested amount of energy to be provided by the second energy source.

15. The method of claim 14, further comprising: performing a variational mode decomposition relative to the request signal to generate the first control signal and the second control signal.

16. The method of claim 14, further comprising:
receiving the request signal;
providing the first control signal to the first energy source; and
providing the second control signal to the second energy source.

17. The method of claim 16, wherein:
providing the first control signal to the first energy source comprises providing the first control signal to one or more of: one or more batteries and one or more ultracapacitors; and
providing the second control signal to the second energy source comprises providing the second control signal to one or more generators.

18. The method of claim 14, further comprising:
generating a residual error signal at least partially responsive to a difference between the second portion of the requested amount of energy indicated by the second control signal and the second energy output of the second energy source; and
providing the residual error signal to the first energy source.

19. The method of claim 14, wherein generating the first control signal and the second control signal comprises generating the first control signal and the second control signal at least partially based on a variational mode decomposition of the request signal.

20. The method of claim 14, wherein the first energy source comprises a third energy source and a fourth energy source, further comprising:
generating a third control signal at least partially responsive to the first control signal;
generate a fourth control signal at least partially responsive to the first control signal;
providing the third control signal to the third energy source; and
providing the fourth control signal to the fourth energy source.
